(19) United States
(12) Patent Application Publication
(10) Pub. No.: US 2011/0187862 A1
(43) Pub. Date: Aug. 4, 2011

(54) STEERING WHEEL GRIP DETECTION APPARATUS AND PROGRAM PRODUCT

(75) Inventor: Takahiro ISHIKAWA, Nagoya-city (JP)

(73) Assignee: DENSO CORPORATION, Kariya-city (JP)

(21) Appl. No.: 12/963,723

(22) Filed: Dec. 9, 2010

(30) Foreign Application Priority Data
Dec. 14, 2009 (JP) 2009-282986

(51) Int. Cl. H04N 7/18

(52) U.S. Cl. 348/148; 348/E07.085

(57) ABSTRACT

A steering wheel grip detection apparatus is disclosed. The apparatus is configured to: acquire information indicative of actual position of a steering wheel in a vehicle compartment; acquire an image captured by an imaging device; identify position of the steering wheel on the image by applying the actual position of the steering wheel to a prescribed correspondence position relationship between the actual position and the position on the image; identify hand position of a person appearing on the image; and determine whether the steering wheel is gripped, based on whether the hand position on the image is on the position of the steering wheel on the image.

### CROSS REFERENCE TO RELATED APPLICATION

The present application is based on and claims priority to Japanese Patent Application No. 2009-282986 field on Dec. 14, 2009, disclosure of which is incorporated herein by reference.

### BACKGROUND OF THE INVENTION

1. Field of the Invention

The present invention relates to a steering wheel grip detection apparatus for detecting grip of a steering wheel of a vehicle, and a program product.

2. Description of Related Art

There is known a steering wheel grip detection apparatus for use in a vehicle having a steering with a steering wheel. This kind of steering wheel grip detection apparatus detects whether the driver is gripping the steering wheel, by using a contact sensor mounted to the steering wheel (see Patent Document 1).

In a typical contact sensor, a contact portion for contacting with a hand (skin) of a driver is made of a metal material. Thus, in a low, temperature situation such as winter etc., the contact portion of the contact sensor has low temperatures. Because of this, when a driver drives a vehicle equipped with the above steering wheel grip detection apparatus, the driver needs to touch the contact sensor having low temperatures with his or her hand and possibly has uncomfortable feeling.

To address this problem, a proposed steering wheel grip detection apparatus includes an imaging device for imaging a prescribed region of a vehicle compartment and an image processing processor for performing image processing on an image captured by the imaging device to detect the grip of the steering wheel (see Patent Document 2).

According to the steering wheel grip detection apparatus utilizing the image processing, the image processing processor identifies position of the steering wheel on the image (referred to also as steer position for simplicity) and position of the hand of the driver on the image (referred to also as hand position for simplicity), and detects the grip of the steering wheel based on a positional relationship between the steer position and the hand position.

A way for the image processing processor to identify the hand position includes extracting an infrared-radiating portion from the image, and designating the position (coordinate) of the extracted infrared-radiating portion as the hand position.

In the steering wheel grip detecting apparatus utilizing the image processing, the steer position is a fixed value representing a single prescribed position in the vehicle compartment of the vehicle.
Patent Document 1: JP-2008-122149A
Patent Document 2: JP-2006-123640A

The inventor of the present application has found the following difficulty.

In a typical vehicle, position of a steering wheel in a vehicle height direction is changeable by a known tilt mechanism. In addition, position of the steering wheel in a longitudinal direction is changeable by a known telescopic mechanism.

When the position of the steering wheel is changed, position of a given portion of the steering wheel on the image captured by the imaging device can be largely changed. For example, as shown in FIG. 9, when the position of the steering wheel is a near lower end of a movable range of the steering wheel, a given pixel of the image corresponds to a left upper portion of the steering wheel. When the position of the steering wheel is a far upper end of the movement range, the same given pixel of the image corresponds to a left lower portion of the steering wheel.

Because of this, the steering wheel grip detection apparatus assuming the steer position as a fixed value may involve a discrepancy between the actual steer position and the steer position recognized by the image processing processor. In this situation, detection result reliability of the steering wheel grip detection apparatus is disadvantageously low.

That is, the steering wheel grip detection apparatus utilizing the image processing has a difficulty that accuracy in steering wheel grip detection is low.

### SUMMARY OF THE INVENTION

In view of the foregoing, it is an objective of the present invention to provide a steering wheel grip detection apparatus utilizing image processing that has high accuracy in steering wheel grip detection. It is also an objective of the present invention to provide a program product for a steering wheel grip detection apparatus.

According to a first aspect of the present invention, a steering wheel grip detection apparatus for a vehicle is provided. The steering wheel grip detection apparatus is configured to acquire position information indicative of position of a steering wheel in a vehicle compartment of the vehicle. The position of the steering wheel is changeable in a movable range thereof. The position of the steering wheel in the vehicle compartment of the vehicle is actual position. The steering wheel grip detection apparatus is further configured to acquire an image captured by an imaging device that is fixed to the vehicle to image a prescribed region of the vehicle compartment so that the prescribed region covers at least the movable range of the steering wheel. The position of the steering wheel on the image is image position. The steering wheel grip detection apparatus is further configured to identify, at least when the actual position is changed, the image position by applying (i) the acquired position information to (ii) a prescribed correspondence position relationship establishing a one-to-one correspondence between the position information and the image position, wherein the identified image position is detection position. The steering wheel grip detection apparatus is further configured to identify hand position of a person appearing on the image from the acquired image. The steering wheel grip detection apparatus is further configured to determine whether the steering wheel is gripped, based on whether the hand position is on the detection position. When the hand position is on the detection position, the steering wheel grip detection apparatus determines that the steering wheel is gripped.

According to a second aspect of the present invention, a program product is provided. The program product is stored in a computer readable storage medium to cause a computer to function as the above steering wheel grip detection apparatus.

According to the above steering wheel grip detection apparatus, it is possible to provide high accuracy in steering wheel grip detection.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram illustrating a schematic configuration of a steering wheel grip detection system;

FIG. 2 is a diagram illustrating specific portions of a steering wheel in connection with a correspondence position relationship;

FIG. 3 is a flowchart illustrating a steer grip detection process;

FIGS. 4A and 4B are diagrams illustrating a way to identify a steering wheel by using piecewise-polynomial interpolation;

FIGS. 5A and 5B are diagrams illustrating a way to detect grip of a steering wheel;

FIG. 6 is a diagram illustrating a way to identify a grip state and a grip position;

FIGS. 7A to 7D are diagrams illustrating a way to identify a grip state according to a modification example;

FIGS. 8A to 8C are diagrams illustrating a way to identify a grip state according to another modification example; and

FIG. 9 is a diagram a change in position of the steering wheel.

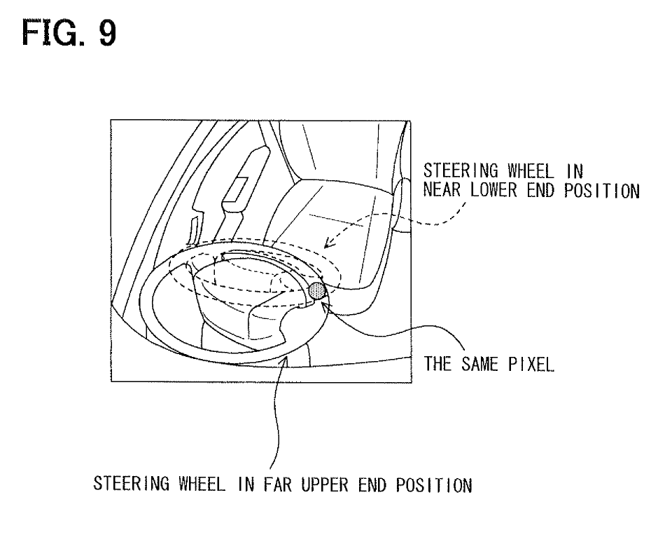

### DETAILED DESCRIPTION OF EMBODIMENTS

Embodiments of the present invention will be described below.

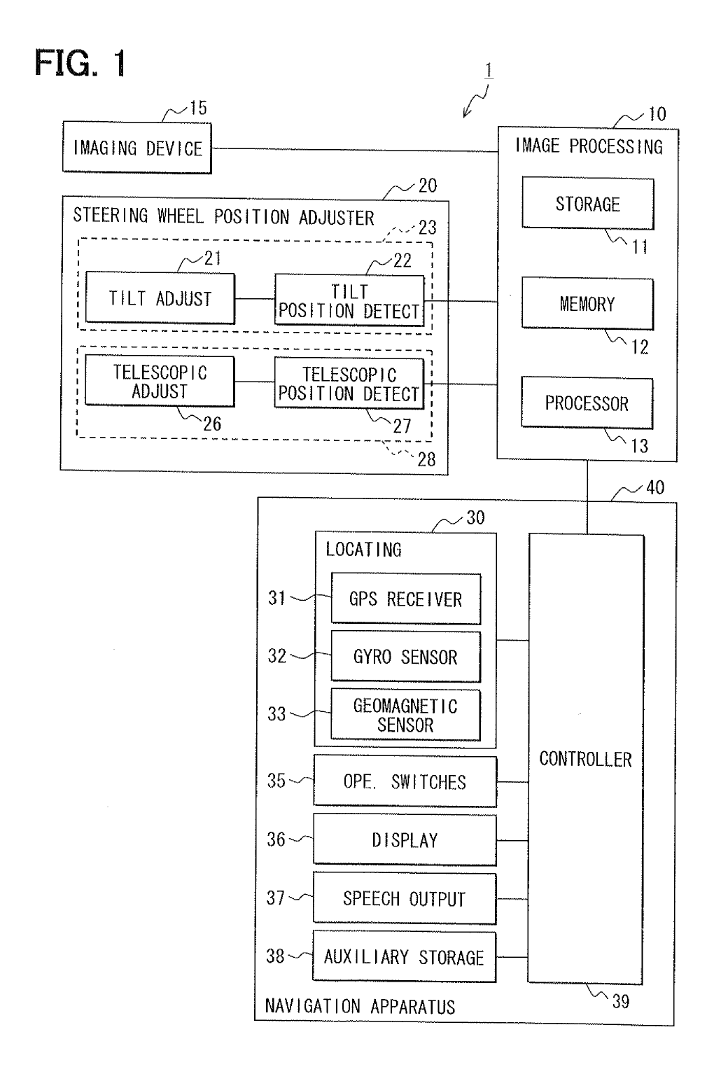

FIG. 1 is a block diagram illustrating a schematic configuration of a steering wheel grip detection system.

<Configuration of Steering Wheel Grip Detection System>

The steering wheel grip detection system 1 illustrated in FIG. 1 is mounted to a vehicle. In the present disclosure, the vehicle equipped with the steering wheel grip detection system 1 is referred to as a subject vehicle.

The steering wheel grip detection system 1 makes a determination at least as to whether a passenger of the vehicle is gripping the steering wheel. When it is determined that the passenger is not gripping the steering wheel, the steering wheel grip detection system 1 gives a warning in a vehicle compartment.

To realize this, the steering wheel grip detection system 1 includes an imaging device 15, a steering wheel position adjust mechanism 20, a navigation apparatus 40 and an image processing processor 10.

The steering wheel position adjust mechanism 20 includes a tilt mechanism 23 and a telescopic mechanism 28. The tilt mechanism 23 allows the steering wheel to be movable in the vehicle height direction of the subject vehicle. The telescopic mechanism 28 allows the steering wheel to be movable in the longitudinal direction of the subject vehicle.

The tilt mechanism 23 includes a tilt adjust mechanism 21 and a tilt position detection mechanism 22. The tilt adjust mechanism 21 can change the position of the steering wheel along the vehicle height direction to a certain position inputted from an external. The tilt position detection mechanism 22 detects the position of the steering wheel along the vehicle height direction. The position of the steering wheel along the vehicle height direction is also referred to as tilt position S_{ch}.

The tilt adjust mechanism 21 includes an electric motor (not shown) as a main component. The electric motor is driven in accordance with an input from an external and thereby changes angle of a steering column with respect to the vehicle height direction. The tilt position detection mechanism 22 includes, as a main component, a rotary encoder for detecting rotation angle of the electric motor. Based on the rotation angle of the electric motor, the tilt position detection mechanism 22 obtains the tilt position S_{ch} in a known manner. The obtained tilt position S_{ch} is outputted to the image processing processor 10.

The telescopic mechanism 28 includes a telescopic adjust mechanism 26 and a telescopic position detection mechanism 27. The telescopic adjust mechanism 26 can change the position of the steering wheel in the longitudinal direction to a certain position inputted from an external. The telescopic position detection mechanism 27 detects the position of the steering wheel in the longitudinal direction. The position of the steering wheel in the longitudinal direction is also refereed to as telescopic position Sₜᵣ.

The telescopic adjust mechanism 26 includes an electric motor (not shown) as a main component. A rack-and-pinion etc. connected to the electric motor is driven in accordance with an input from an external, and thereby, a projection amount of the steering column into the vehicle compartment is changed. The telescopic position detection mechanism 27 includes, as a main component, a rotary encoder for detecting rotation angle of the electric motor. Based on the rotation angle of the electric motor, the telescopic position detection mechanism 27 obtains telescopic position Sₜᵣ. The obtained telescopic position Sₜᵣ is outputted to the image processing processor 10.

In the following, the tilt position S_{ch} and the telescopic position Sₜᵣ are collectively referred to also as steer position information (S_{ch,tr}). The steer position information (S_{ch,tr}) corresponds to position information indicative of actual position of the steering wheel in the vehicle compartment. In the steer position information (S_{ch,tr}), the position of the steering wheel in the vehicle compartment is expressed using a sensor space in which numerical values detected by the tilt position detection mechanism 22 and the telescopic position detection mechanism 27 exist.

The imaging device 15 includes a digital camera as a main component. The imaging device 15 is arranged at and fixed to a prescribed place (e.g., inside a room mirror) in the vehicle compartment to image a space covering at least at least the movable range of the steering wheel. Every time the imaging device 15 captures an image, the imaging device 15 outputs the captured image to the image processing processor 10.

The navigation apparatus 40 includes a location detection device 30, a group of operation switches 35, a display device 36, a speech output device 37, an auxiliary storage device 38 and a control device 39 (i.e., controller 39). The location detection device 30 detects present location of the subject vehicle. The location detection device 30 includes at least a GPS receiver 31, a gyro-sensor 32, and a geomagnetic sensor 33. The GPS receiver 31 receives radio wave from GPS (Global Positioning System) artificial satellites via a GPS antenna (not shown) and outputs received signals. The gyro-sensor 32 detects magnitude of rotation of the subject vehicle. The geomagnetic sensor 33 detects heading direction of the subject vehicle by using geomagnetism.

The display device 36 displays information in accordance with a signal from the controller 39. The display device 36 is for example a liquid crystal display device. The speech output device 37 includes, as a main component, a speaker for converting and outputting a signal from the controller 39.

The group of operation switches 35 accepts various instructions from a passenger. The auxiliary storage device 38 includes a non-volatile rewritable memory device such as a hard disk drive, a flash memory and the like. The auxiliary storage device 38 stores therein map data (e.g., node data, link data, cost data, road data, topography data, terrain data, mark data, intersection data, facility data etc.), speech data for guidance, speech recognition data and the like.

The controller 39 includes, as a main component, a microcomputer having at least ROM, RAM and CPU. The controller 39 executes a processing program to calculate the present location of the subject vehicle, the heading direction of the subject vehicle and the like based on output signals from the location detection device 30 (i.e., the GPS receiver, and respective sensors). Moreover, the controller 39 executes a processing program to provide a known navigation function to the navigation apparatus 40. The navigation function includes, for example, route guidance to a destination based on the present location and the heading direction of the subject vehicle, wherein the destination may be set in accordance with an input from an external.

The image processing processor 10 includes, as a main component, a microcomputer having a storage device 11, and a memory 12 and a processor 13. The storage device 11 retains stored information even when not powered, and is capable of rewriting the stored information. The storage device 11 is, for example, a flash memory or the like. The memory 12 stores therein data that may be temporarily generated in course of processing. The memory 12 can temporarily store therein the captured image inputted from the imaging device 15. The processor 13 performs processing based on a program stored in the storage device 11, the memory 12 or the like.

The storage device 11 stores therein a processing program that causes the processor 13 to perform a steer grip detection process, which at least includes successive image processing on the captured image inputted from the imaging device 15. In the steer grip detection process, the position (i.e., region) of the steering wheel on the captured image is identified, and a steer grip determination is made. The steer grip determination is a determination as to whether the identified region (i.e., position) of the steering wheel is gripped. Moreover, in the steer grip detection process, a warning is issued when a result of the steer grip determination is that the steering wheel is not gripped.

The storage device 11 stores therein a steer correspondence position relationship, which the processor 13 refers to when performing the steer grip detection process. The steer correspondence position relationship is used to identify a set of pixels of the captured image representing the steering wheel on the basis of on the steer position information (S_{ch,tr}). The pixels representing the steering wheel are also referred to as a set of image points (Iₓ, I_{y}). The pixels representing the steer image position corresponds to the position of the steering wheel on the image and also called image position.

In the steer correspondence position relationship, the steer position information (S_{ch,tr}) is prospectively associated with the image points (Iₓ, I_{y}) that are to be actualized when the steering wheel in the vehicle compartment is in a position determined by the steer position information (S_{ch,tr}). In other words, in the steer correspondence position relationship, the image points (Iₓ, I_{y}) have a one-to-one correspondence to a combination of the telescopic position Sₜᵣ, and the tile position S_{ch}.

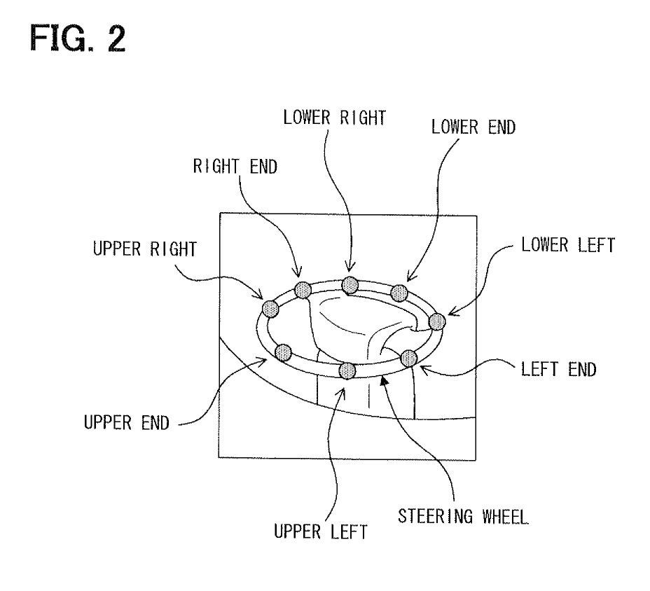

It should be noted that, in the steer correspondence position relationship of the present embodiment, the image points (Iₓ, I_{y}) are associated with the steer position information (S_{ch,tr}) with respect to each of multiple prescribed portions of the steering wheel. The multiple prescribed portions of the steering wheel are also referred to as specific portions. As shown in FIG. 2, the specific portions can be expressed as relative portions of the steering wheel in the vehicle compartment. In the present embodiment, an upper end portion, a right upper portion, a right end portion, a right lower portion, a lower end portion, a left lower portion, a left end portion, and a left upper portion of the steering wheel are predetermined as the specific portions, as shown in FIG. 2. The image points (Iₓ, I_{y}) representing portions of the steering wheel other than the specific portions are predetermined by using an approximate expression that approximately expresses image points between two adjacent specific portions (e.g., the upper end portion and the right upper portion) as a straight line or a curved line. When the approximate expression provides the curved line, the image points (Iₓ, i_{y}) may be set with respect to each steer position information (S_{ch,tr}).

The steer correspondence position relationship of the present embodiment includes a data map and a formula for position computation. In the data map, the steering position information (S_{ch,tr}) has one-to-one correspondence to the image points (Iₓ, I_{y}) of the specific portions itself. The formula for position computation is an expression for calculation of the image points (Iₓ, I_{y}) of the specific portions from the steer position information (S_{ch,tr}).

The image points (Iₓ, I_{y}) associated with the steering position information (S_{ch,tr}) in the data map are ones to be actualized when the steering wheel is in representative positions. The representative positions are multiple preset positions of the steering wheel in the movable range of the steering wheel. In the present embodiment, the representative positions of the steering wheel include a farmost lower end, a farmost upper end, a near lower end, a near upper end, and a position center. The representative positions are also referred to as specific positions.

In the farmost lower end, the telescopic position of the steering wheel is a front end of the movable range in a vehicle front-rear direction, and the tilt position of the steering wheel is a lower end of the movable range in the vehicle height direction. In the farmost upper end, the telescopic position of the steering wheel is the front end of the movable range in the vehicle front-rear direction, and the tilt position of the steering wheel is an upper end of the movable range in the vehicle height direction. In the near lower end, the telescopic position of the steering wheel is the rear end of the movable range in the vehicle front-rear direction, and the tilt position of the steering wheel is the lower end of the movable range in the vehicle height direction. In the near upper end, the telescopic position of the steering wheel is the rear end of the movable range in the vehicle front-rear direction, and the tilt position of the steering wheel is the upper end of the movable range in the vehicle height direction. The position center is an intersection point of two straight lines; one is a straight line interconnecting the farmost lower end and the near upper end; and the other is a straight line interconnecting the farmost upper end and the near lower end.

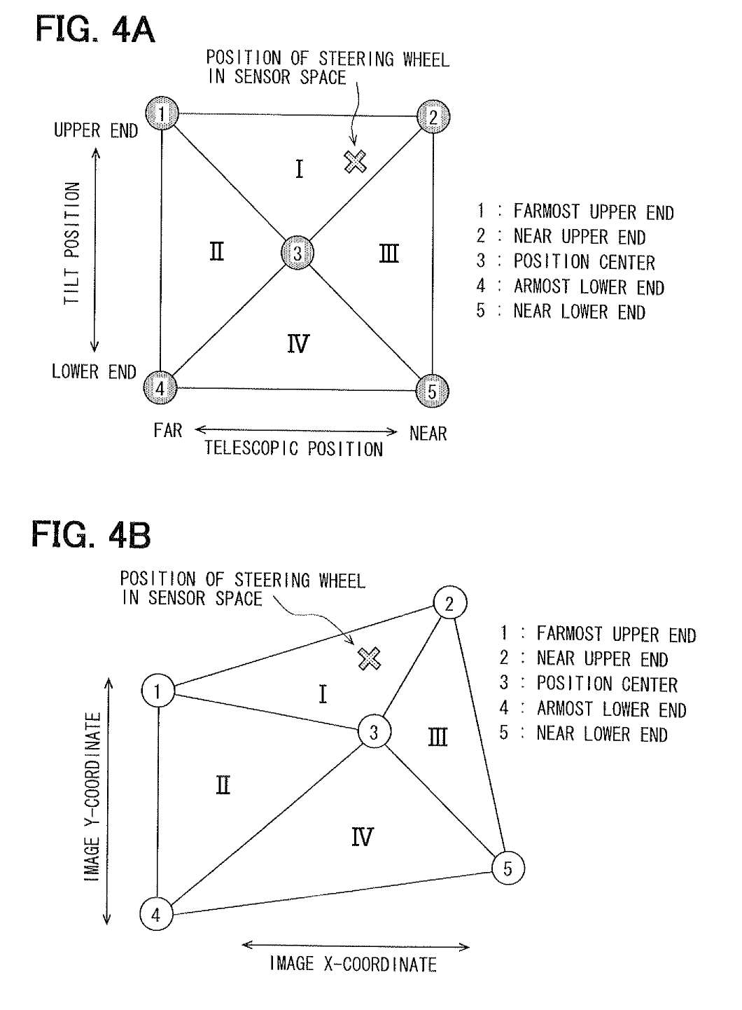

The formula for position computation is a predetermined expression and is derived from experiments or the like, so that the formula can identify the image points (Iₓ, I_{y}) corresponding to each of position of the steering wheel other than the representative positions. The formula may be set on a position estimation region “i” basis. Each position estimation region “i” is a region surrounded by the preset number of representative positions. In the present embodiment, each position estimation region “i” is surrounded by three representative positions, as shown in FIGS. 4A and 4B by the position estimation regions I, II, III and IV. The formula includes four expressions given as:

Iₓ^{now}=a₁ⁱα+a₂ⁱβ+a₃ⁱ (1)

I_{y}^{now}=a₄ⁱα+a₅ⁱβ+a₆ⁱ (2)

α=S_{ch}^{now}−S_{ch}^{ib} (3)

β=Sₜᵣ^{now}−Sₜᵣ^{ib} (4)

where “a” is a constant that is predetermined by experiments or the like.

In the above expressions (1) to (4), the suffix “now” shows that the image points (Iₓ, I_{y}) and the steering position information (S_{ch,tr}) with the suffix “now” are ones at present. In the expressions (3) and (4), the suffix “ib” shows that the steering position information (S_{ch,tr}) with the suffix “ib” corresponds to one representative position determined with respect to each position estimation region “i”. The one representative position determined with respect to each position estimation region “i” is one of the three representative positions forming the position estimation region “i”, and has the telescopic position Sₜᵣ close to the front end (i.e., farmost) of the movable range in the vehicle front-rear direction among the three representative positions. When it is assumed that the multiple representative positions are the same in the telescopic position, the one has the tilt position S_{ch} closest to the upper end of the vehicle.

In other words, in response to an input of certain steer position information (S_{ch,tr}), the steer correspondence position relationship outputs a group of image points (Iₓ,I_{y}) that is to be actualized when the steering wheel is in a position designated by the certain steer position information (S_{ch,tr}).

<Steer Grip Detection Process>

Next, explanation will be given on the steer grip detection process performed by the image processing processor 10 (more specifically, the processor 13).

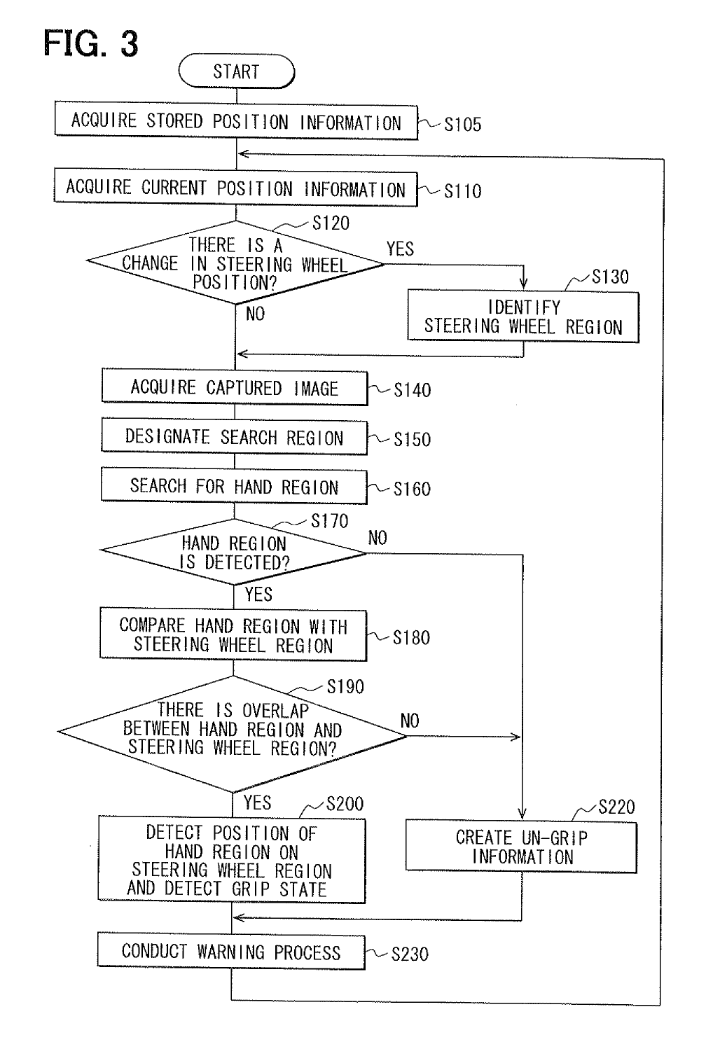

FIG. 3 is a flowchart illustrating the steer grip detection process. The steer grip detection process is performed when the image processing processor 10 is started up or when an ignition signal is inputted. When the image processing processor 10 is halted or when the input of the ignition signal is stopped, the steer grip detection process is ended after termination is preformed. In the termination, the steer position information S_{ch,tr} inputted at an timing of end of the steer grip detection process and the group of image points Iₓ, I_{y} (i.e., the steer region) identified at the timing of end of the steering wheel grip detection process are stored in the storage device 11.

As shown in FIG. 3, when the steer grip detection process is started, the following is performed. At S105, from the storage device, the image processing processor 10 acquires the position of the steering wheel on the captured image and the steer position information (S_{ch,tr}) stored in the storage device 11. At S105, in addition, the image processing processor 10 loads the acquired group of image points (Iₓ, I_{y}) on the memory 12. It should be noted that the steer position information (S_{ch,tr}) and the image points (Iₓ, I_{y}) acquired at S105 are ones that were stored in the storage device 11 at the termination of the previous steer grip detection process.

At S110, the image processing processor 10 acquires the tilt position S_{ch} from the tilt position detection mechanism 22 and the telescopic position Sₜᵣ from the telescopic position detection mechanism 27. That is, at S110, the steer position information (S_{ch,tr}) is acquired.

At S120, the image processing processor 10 determines whether a change in value between the steer position information (S_{ch,tr}) acquired at S110 and the previously-acquired steer position information (S_{ch,tr}) is greater than or equal to a prescribed value. When it is determined that the change is greater than or equal to the prescribed value, corresponding to YES at S120, it is determined that the position of the steering wheel is changed, and the process proceeds to S130.

The previously-acquired steer position information (S_{ch,tr}) recited in the above is steer position information (S_{ch,tr}) acquired at S105, when the process proceeds to S120 for the first time after the start of the steer grip detection process. When the process proceeds to S120 for the second time or the subsequent time after the start of the steer grip detection process, the previously-acquired steer position information (S_{ch,tr}) is steer position information (S_{ch,tr}) acquired, at S110 in the previous cycle. In the above, the cycle means a flow of processes from S110 to S230.

At S130, the image processing processor 10 applies (i) the steer position information (S_{ch,tr}) acquired at S110 in this cycle to (ii) the steer correspondence position relationship stored in the storage device 11. Thereby, the image processing processor 10 identifies a group of image points (Iₓ, I_{y}) corresponding to the steer position information (S_{ch,tr}) at the present time. In the above, the identified group of image points (Iₓ, I_{y}) can act as the image position corresponding to detection position, and shows a steer region. At S130, the identified steer region is loaded on the memory 12.

FIGS. 4A and 4B are diagrams illustrating a way to identify the image points (Iₓ, I_{y}) by using the formula for position computation in the steer position correspondence relationship. Specifically, FIG. 4A is a diagram illustrating the position of the steering wheel in the sensor space. FIG. 4B is a diagram illustrating the image points (Iₓ, I_{y}) corresponding to the position of the steering wheel shown in FIG. 4A.

In a case of FIG. 4A, the steering wheel is positioned in the position estimation region “I”, which has vertexes at the farmost upper end, the near upper end and the position center. In this case, at S130, the steer position information (S_{ch,tr}) indicative of this position is substituted into the formula for position calculation corresponding to the position estimation region “I”. Thereby, as shown in FIG. 4B, the group of image points (Iₓ, I_{y}) is obtained, and the position of the steering wheel on the captured image is identified.

When the steering wheel is in the representative position, the group of image points (Iₓ, I_{y}) corresponding to the representative position is read out from the data map. After S130, the process proceeds to S140.

When it is determined at S120 that the change in the steer wheel position information (S_{ch,tr}) is less than the prescribed value, it is determined that the position of the steering wheel has not been changed, and the process proceeds to S140.

At S140, the image processing processor 10 acquires the image captured by the imaging device 15. At S150, the image processing processor 10 designates a search region so that the search region covers at least the steer region loaded on the memory 12. That is, the search region is set larger than the steer region.

At S160, the image processing processor 10 searches the search region set at S150 for a hand region representing a hand of a person (e.g., driver) appearing on the captured image. The search for the hand region may be conducted by a known method used in image processing such as pattern matching method, a background differencing technique and the like.

When the hand region exists in the search region, the hand region is detected at S160. When the hand region does not exist in the search region, the hand region is not detected at S160. At S170, the image processing processor 10 determines whether at least one hand region is detected in the search region at S160. When it is determined that at least one hand region is detected in the search region, the process proceeds to S180.

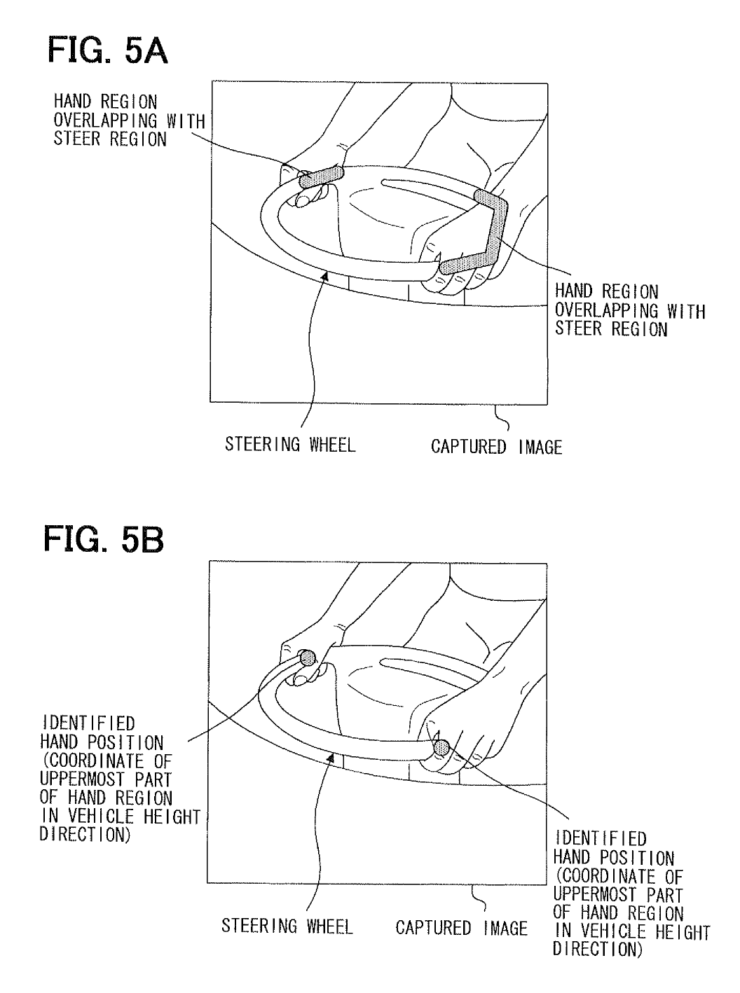

At S180, the at least one hand region detected at S160 is compared with the steer region loaded on the memory 12. At S190, it is determined whether there is an overlap between the at least one hand region and the steering region, based on the comparison made at S180. When it is determined that there is the overlap between the at least one hand region and the steering region, the determination “YES” is made at S190, and the process proceeds to S200. For example, as shown in FIG. 5A, when the same coordinate is shared by a group of coordinates forming the hand region and a group of coordinates forming the steering region, it is determined that the steering wheel is gripped with at least one hand, and the process proceeds to S200. In the present embodiment, when the process proceeds to S200, the coordinate (i.e., pixel) located uppermost of the overlapped portion of the hand region in the vehicle height direction is identified as a hand position in the captured image (referred to also as an identified hand position). In the above, the overlapped portion of the hand region is a portion of the hand region overlapping with the steer region.

At S200, the image processing processor 10 identifies a grip state and a grip position on the steering wheel. The image processing processor 10 identifies the grip state by obtaining the number of identified hand positions. For example, when the number of identified hand positions is unity, the grip state is identified as a one-hand grip state where the steering wheel is gripped with one hand. When the number of identified hand positions is two, the grip state is identified as a both-hands grip state where the steering wheel is gripped with both hands.

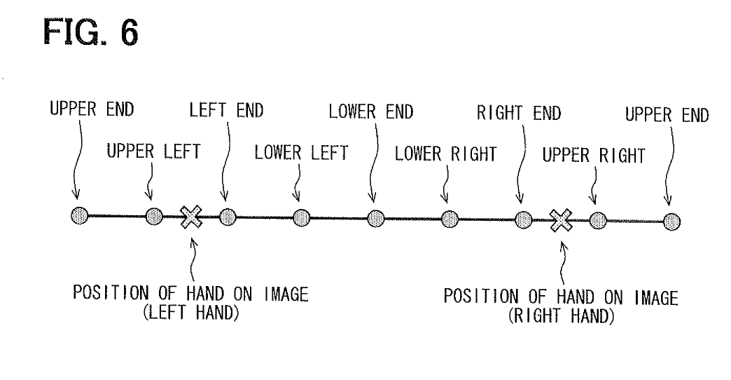

In the present embodiment, the image processing processor 10 identifies the grip position by detecting a region between the specific portions, the region containing the identified hand position. Specifically, as shown in FIG. 6, the steer region is deformed into a straight line shape, and the identified hand position is placed on the deformed steer region. In this way, the region containing the identified hand position between the specific portions in the captured image is detected.

In an example case shown in FIG. 6, one identified hand position is detected between the two specific portions, i.e., between the upper left portion and the left end portion. Thus, a region between the left upper specific portion and the left end specific portion is identified as the grip position. In the example case shown in FIG. 6, another identified hand position is detected between the right upper portion and the right end portion. Thus, a region between the right upper portion and the right end portion is identified as another grip position.

In other words, the grip position and the grip state can be identified at S200 in the following way. Multiple prescribed points on the steering wheel are designated as specific points. A region between two of the specific points, the region containing the identified hand position (i.e., detection position), is identified as a grip position. The grip state is identified from the grip position.

In the following, the grip state and the grip position identified at S200 are referred, to also as steer grip information. After S200, the process proceeds to S230. When it is determined at S170 that no hand region is detected in the search region, the process proceeds to S220. When it is determined at S190 that there is no hand region overlapping with the steer region, the process proceeds to S220.

That is, when the steering wheel is not gripped, the process proceeds to S220. At S220, as the grip state, the image processing processor 10 creates non-grip information indicating that the steering wheel is not gripped.

At S230, when the non-grip information is created in this cycle, the image processing processor 10 performs at least a warning process to output a control command to instruct the navigation apparatus 40 to output a warning to an inside of the vehicle compartment.

In the warning process of the present embodiment, when the grip state is the one-hand grip state, and when information on travel circumstances of the subject vehicle acquired form the navigation apparatus 40 or the like meets a prescribed condition, the image processing processor 10 may output the control command to instruct the navigation apparatus 40 to output the warning to the inside of the vehicle compartment. In the present embodiment, for example, the warning process to be performed in the one-hand grip state may include the followings. When the travel circumstances acquired from the navigation apparatus 40 indicates that curvature of a road on which the subject vehicle is going to travel is greater than or equal to a prescribed value, the image processing processor 10 may output the control command before the subject vehicle goes into the curved road. In addition, when speed of the subject vehicle is greater than or equal to a prescribed value in the one-hand grip state, the image processing processor 10 outputs the control command.

The warning process to be preformed in the one-hand grip state is also described in JP-A-2008-122140, the assignee of which is the same as the present application. After S230, the process returns to S110, and S110 to S230 are cyclically performed.

That is, in the steer grip detection process of the present embodiment, the position of the steering wheel on the captured image (i.e., the steer region) is identified based on the steer position information inputted from the steering wheel position adjust mechanism 20. In addition, the hand region is identified from the captured image. Then, a steer grip determination is made based on the comparison between the identified steer region and the identified hand region. When a result of the steer grip determination is that the steering wheel is not gripped and the grip state is in a non-grip state, the warning is outputted.

[Advantage]

According to the steering wheel grip detection system 1 of the present embodiment, when a change in position of the steering wheel is made, the steer region corresponding to the position of the steering wheel after the change is identified. Therefore, the steer detection process of the present embodiment can advantageously allow the steer region to consistently correspond to the actual position of the steering wheel.

In the steer grip detection process, when a hand region overlapping with the steer region exists, it is determined that the steering wheel is gripped. Therefore, the steering wheel grip detection system 1 of the present embodiment, which consistently designates the steer region corresponding to the actual position of the steering wheel, can improve accuracy in detecting the grip of the steering wheel.

In addition, since the steering wheel grip detection system 1 of the present embodiment consistently designates the steer region corresponding to the actual position of the steering wheel, it is possible to improve accuracy in detecting the grip sate and the grip position of the steering wheel.

As a result, a possibility that an unneeded warning is notified at the warning process and the uncomfortable feeling is provided to the passenger can be reduced.

### Other Embodiments

Embodiments of the present invention are not limited to the above-described embodiments. Embodiments of the present invention can have various forms without departing from the scope and spirit of the present invention.

In the above-described embodiment, the representative positions are five positions, i.e., the farmost lower end, the farmost upper end, the near lower end, the near upper end and the center position. However, the representative positions are not limited to these five positions. For example, a representative position may be set between each pair of adjacent representative positions, of the above five representative positions. Specifically, a representative position may be set at, for example, a midpoint between the farmost lower end and the near lower end, or may be set at a position spaced apart from the farmost lower end by one-Nth of a distance between the farmost lower end and the near lower end, where N is arbitrary integer. Alternatively, the representative positions may be four positions that are the farmost lower end, the farmost upper end, the near lower end and the near upper end. The number of representative positions may be any number from 4 to N, where N is arbitrary integer greater than or equal to 4.

In the above-described embodiment, the formula for position computation (see the above-described expressions (1) to (4) in the steer correspondence relationship) is written as a linear equation. Alternatively, the formula for position computation may be written as a quadratic equation or a polynomial with degree greater than 2.

In the above-described embodiment, the steer correspondence position relationship includes the data map and the formula for position calculation. Alternatively, the steer correspondence position relationship may include only the data map, or may include only the formula for position computation.

In the above-described embodiment, the search region is set larger than the steer region in the steer grip detection process. Alternatively, the search region and the steer region may be the same. In this case, since the region searched for a hand becomes smaller, it is possible to reduce an amount of processing required to detect whether the steering wheel is gripped. Therefore, after acquisition of the captured image, it is possible to reduce a time taken to detect whether the steering wheel is gripped.

When the search region and the steer region are set as the same region, S180 and S190 in the steer grip detection process may be omitted. In the above-described embodiment, the grip position and the grip state of the steering wheel are identified in multiple steps at S180 to S200 and S220. Alternatively, the grip position and the grip state of the steering wheel may be identified at a single step.

In this case, a classification pattern in which the steer state and the grip position are classified may be prepared in advance. The steer region and the hand region identified at the steer grip detection process may be compared with the classification pattern. Thereby, the grip position and the grip state of the steering wheel may be identified. In the classification pattern, combinations of the steer region and the hand region should be prospectively associated with combinations of the grip state and the grip position.

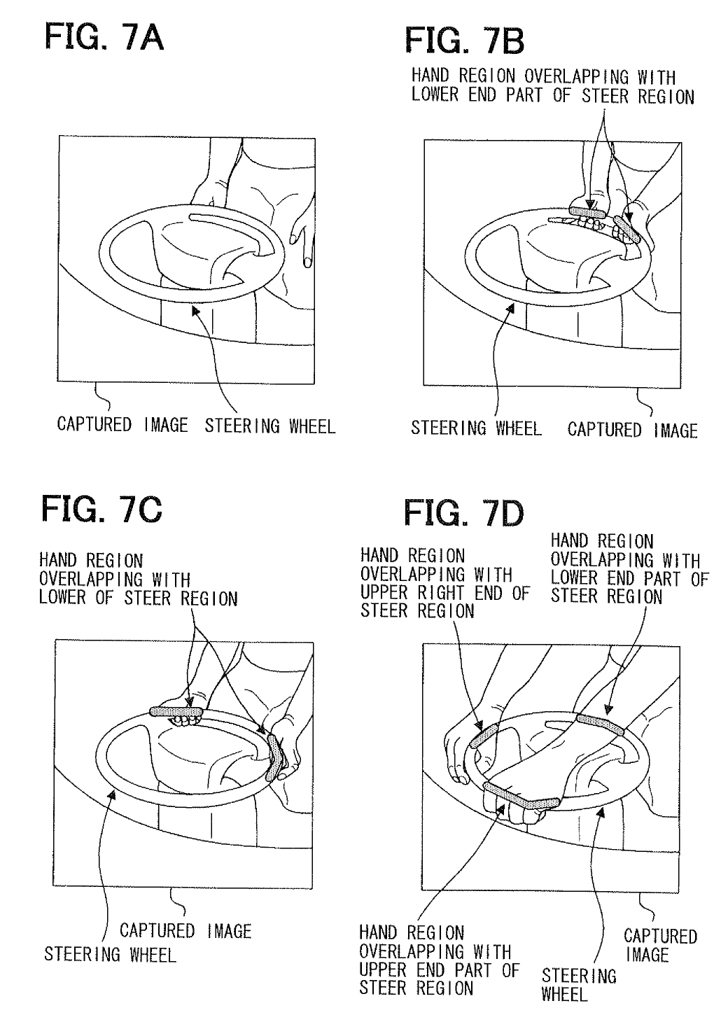

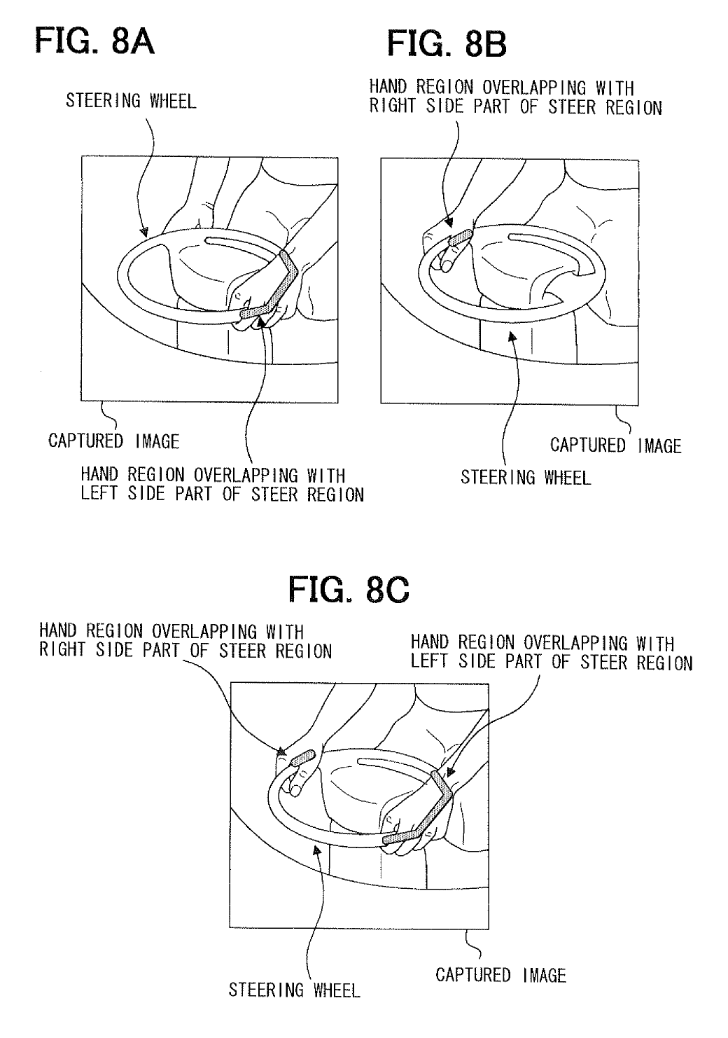

FIGS. 7A to 7D and FIGS. 8A to 8C are diagrams illustrating the classification pattern. The classification pattern may designate the following combinations of the grip state and the grip position. As shown in FIG. 7A, the classification pattern may designate the non-grip state in which there is no overlap between the steer region and the hand region. As shown in FIG. 7B, the classification pattern may further designate, as the grip state and the grip position, a both-hand grip state and a lower end portion grip position in which two hand regions overlaps with the lower end of the steer region. Further, as shown in FIG. 7C, the classification pattern may designate, as the grip state and the grip position, the both-hand grip state and a middle portion grip position in which the two hand regions overlap with portions of the steer region upper than the lower end of the steer region. Further, as shown in FIG. 7D, the classification pattern may designate, as the grip state and the grip position, the both-hand grip state and an upper portion grip position in which: three hand regions overlap with the steer region; a first one of the three hand regions overlaps with the lower upper end of the steer region; a second one overlaps with the upper end of the steer region; and a third one overlaps with the upper right end of the steer region.

Further, as shown in FIG. 8A, the classification pattern may designate, as the grip state and the grip position, the one-hand grip state and a middle portion grip position in which one hand region overlaps with the left side portion of the steer region. Further, as shown in FIG. 8B, the classification pattern may designate, as the grip state and the grip position, the one-hand grip state and a middle portion grip position in which one hand region overlaps with the right side portion of the steer region. Further, as shown in FIG. 8C, the classification pattern may designate, as the grip state and the grip position, the both-hand grip state and a middle portion grip position in which: two hand regions overlap with the steer region; one of the two hand regions overlaps with the right-side portion of the steering wheel; and the other overlaps with the left-side portion of the steer region; and the overlapped left-side portion is longer than the overlapped right-side portion.

In the above-described embodiment, the steer position information (S_{ch,tr}) is derived by the tilt position detection mechanism 22 or the telescopic position detection mechanism 27. Alternatively, the steer position information (S_{ch,tr}) may be derived by the image processing processor 10. In this case, as long as the image processing processor 10 can finally acquire the steer position information (S_{ch,tr}), a configuration for deriving the steer position information (S_{ch,tr}) may not matter. In addition, as long as the image processing processor 10 can finally acquire the steer position information (S it may not be matter what information (signal) is inputted to the image processing processor 10.

In the above-described embodiment, each of the tilt adjust mechanism 21 and the telescopic mechanism 28 is configured to include an electric motor as a main component. Alternatively, one or both of the tilt adjust mechanism 21 and the telescopic mechanism 28 may not include an electric motor. In this case, in response to manual operation on a lever, one or both of the tilt adjust mechanism 21 and the telescopic mechanism 28 may change the position of the steering wheel by driving a rack-and-pinion linked to the lever.

When the one or both of the tilt adjust mechanism 21 and the telescopic mechanism 28 is configured to change the position of the steering wheel in response to operation on the lever, a corresponding one or both of the tilt position detection mechanism 22 and the telescopic position detection mechanism 27 may use a known position sensor to detect the tilt position S_{ch} or the telescopic position Sₜᵣ.

In the above-described embodiment, the steer position information (S_{ch,tr}) includes both of the tile position S_{ch} and the telescopic position Sₜᵣ. Alternatively, the steer position information (S_{ch,tr}) may include both of the tile position S_{ch} and the telescopic position Sₜᵣ.

The imaging device 15 may take an image with a visible light only.

Alternatively, the imaging device 15 may take an image with an infrared light etc. The imaging device 15 may include a lighting device for illuminating an imaging region (i.e., a region to be imaged) during the night.

<Aspect>

In the above-described embodiments, S110 in the steer grip detection process, which is performed by the image processing processor 10, can act as an example of position information acquisition means or unit. S140 in the steer grip detection process can act as an example of image acquisition means or unit, S120 and S130 in the steer grip detection process can act as an example of position identification means or unit. S160 in the steer grip detection process can act as an example of hand identification means or unit. S170 to S190 in the steer grip detection process can act as an example of determination means or unit.

S200 in the steer grip detection process can act as an example of grip state determination means or unit, and grip state identification means or unit. S230 in the steer grip detection process can act as an example of warning means or unit.

According to a first aspect of the preset disclosure, a steering wheel grip detection apparatus for a vehicle is provided. The steering wheel grip detection apparatus includes: a position information acquisition unit configured to acquire position information indicative of position of a steering wheel in a vehicle compartment of the vehicle, wherein the position of the steering wheel is changeable in a movable range thereof, wherein the position of the steering wheel in the vehicle compartment of the vehicle is actual position; an image acquisition unit configured to acquire an image captured by an imaging device that is fixed to the vehicle to image a prescribed region of the vehicle compartment so that the prescribed region covers at least the movable range of the steering wheel, wherein the position of the steering wheel on the image is image position; a position identification unit configured to identify, at least when the actual position is changed, the image position by applying (i) the position information acquired by the position information acquisition unit to (ii) a prescribed correspondence position relationship establishing a one-to-one correspondence between the position information and the image position, wherein the identified image position is detection position; a hand identification unit configured to identify hand position of a person appearing on the image from the image acquired by the image acquisition unit; and a determination unit configured to determine whether the steering wheel is gripped, based on whether the hand position identified by the hand identification unit is on the detection position identified by the position identification unit, wherein when the hand position identified by the hand identification unit is on the detection position identified by the position identification unit, the determination unit determines that the steering wheel is gripped.

According to the above steering wheel grip detection apparatus, when a change in the actual position is made, the steering wheel grip detection apparatus applies (i) the position information corresponding to the actual position after the change to (ii) the correspondence position relationship, so that the detection position identified by the steering wheel grip detection apparatus is the image position corresponding to the actual position after the change.

When the hand position is on the detection position corresponding to the actual position of the steering wheel, the steering wheel grip detection apparatus determines that the steering wheel is griped. Therefore, it is possible to improve accuracy in detecting the grip of the steering wheel.

The correspondence position relationship may include data establishing a one-to-one correspondence between the image positions and all of the possible positions of the steering wheel in the movable range. However, the data of this correspondence position relationship may be huge and memory-hogging for a memory storing the correspondence position relationship.

In view of this, the steering wheel grip detection apparatus may be configured in the following way. The correspondence position relationship may designate two or more prescribed actual positions as specific positions; establishes the one-to-one correspondence between (i) the position information indicative of each specific position and (ii) the image position corresponding to the each specific position; and establishes a relation between (i) the actual position other than the specific positions and (ii) the image position corresponding to the actual position other than the specific positions, by using piecewise-polynomial interpolation with an expression derived from the one-to-one correspondence between the position information indicative of each specific position and the image position corresponding to the each specific position. In this case, a formula for computation or the like may describe the relation between (i) the actual position other than the specific positions and (ii) the image position corresponding to the actual position other than the specific positions. In the above, the specific points are respectively at least two or more prescribed actual positions. It may be preferable that the specific points be representative positions of the steering wheel in the movable range.

According to the above correspondence position relationship, it is possible to prevent the correspondence position relationship from being memory-hogging for the memory storing the correspondence position relationship.

The steering wheel grip detection apparatus may to further include a grip state identification unit configured identify a grip state of the steering wheel when the determination unit determines that the steering wheel is gripped.

In the above, the grip state to be identified by the grip state identification unit may include a both-hands grip state where the steering wheel is gripped with both hands and a one-hand grip state where the steering wheel is gripped with one hand.

To identify the both-hands grip state, the steering wheel grip detection apparatus may be configured in the following way. The grip state identification unit identifies the grip state as the both-hands grip state where the steering wheel is gripped with both hands, when the number of hand positions identified by the hand identification unit is two or more and when the identified two or more hand positions are on the detection position identified by the position identification unit.

According to the above configuration, since the steering wheel grip detection apparatus identifies the detection position corresponding to the actual positions, it is possible to detect with high accuracy that the steering wheel is gripped with both hands.

To identify the one-hand grip state, the steering wheel grip detection apparatus may be configured in the following way. The grip state identification unit identifies the grip state as the one-hand grip state where the steering wheel is gripped with one hand, when the number of hand positions identified by the hand identification unit is one and when the identified one hand position is on the detection position identified by the position identification unit.

According to the above configuration, since the steering wheel grip detection apparatus identifies the detection position corresponding to the actual position, it is possible to detect with high accuracy that the steering wheel is gripped with one hand.

The grip state to be identified by the grip state identification unit may be grip position on the steering wheel. The grip position indicates where the hand of the driver gripping the steering wheel is positioned on the steering wheel.

To identify the grip position as the grip state, the steering wheel grip detection apparatus may be configured in the following way. The grip state identification unit may designate multiple prescribed points on the steering wheel as specific points. The grip state identification unit may identify, as a grip position on the steering wheel, a region between two of the specific points, the region containing the detection position identified by the hand identification unit. The grip state identification unit may identify the grip state from the grip position.

According to the above configuration, since the steering wheel grip detection apparatus detects the grip position by using the detection position corresponding to the actual position, it is possible to improve the accuracy in detecting the grip position. In detecting the grip state and the grip position, the steering wheel grip detection apparatus may identify the grip state and the grip position only by comparing the identified hand position with the detection position. Alternatively, in order to detect the grip state and the grip position, a classification pattern classifying the grip state and the grip position the steering wheel grip may be preliminarily prepared, and the steering wheel grip apparatus may identify the grip state and the grip position by comparing the identified detection position and hand position with the classification pattern. In the above, the classification pattern needs to describe a relation between (i) a combination of the identified detection position and hand position and (ii) a combination of the grip state and the grip position.

When the determination unit determines that the steering wheel is not gripped, it may be preferable to give a warning to a passenger of the vehicle. For this reason, the steering wheel grip detection apparatus may further include a warning unit configured to output a warning for safe driving of the vehicle when the determination unit determines that the steering wheel is not gripped. According to the above configuration, it is possible to output the warning at least when the steering wheel is not gripped. Then, a driver can recognize the warning and grip the steering wheel to conduct safe driving

According to a second aspect, a program product for causing a computer to function as the above-described steering wheel grip detection apparatus is provided.

The above program product is stored in a computer readable storage medium such as a DVD-ROM, a CD-ROM, a hard disk drive and the like, and can be loaded and started in the computer on a needed-basis, or can be acquired and started via a communication network.

While the invention has been described above with reference to various embodiments thereof, it is to be understood that the invention is not limited to the above described embodiments and constructions. The invention is intended to cover various modifications and equivalent arrangements.

Further, each or any combination of procedures, processes, steps, or means explained in the above may be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units may be included in a software program, which is contained in a computer-readable storage media or is installed in a computer via a communications network.

What is claimed is:

1. A steering wheel grip detection apparatus for a vehicle, comprising:
position information acquisition means for acquiring position information indicative of position of a steering wheel in a vehicle compartment of the vehicle, wherein the position of the steering wheel is changeable in a movable range thereof, wherein the position of the steering wheel in the vehicle compartment of the vehicle is actual position;
image acquisition means for acquiring an image captured by an imaging device that is fixed to the vehicle to image a prescribed region of the vehicle compartment so that the prescribed region covers at least the movable range of the steering wheel, wherein the position of the steering wheel on the image is image position;
position identification means for identifying, at least when the actual position is changed, the image position by applying (i) the position information acquired by the position information acquisition means to (ii) a prescribed correspondence position relationship establishing a one-to-one correspondence between the position information and the image position, wherein the identified image position is detection position;
hand identification means for identifying hand position of a person appearing on the image from the image acquired by the image acquisition means; and
determination means for determining whether the steering wheel is gripped, based on whether the hand position identified by the hand identification means is on the detection position identified by the position identification means, wherein when the hand position identified by the hand identification means is on the detection position identified by the position identification means, the determination means determines that the steering wheel is gripped.

2. The steering wheel grip detection apparatus according to claim 1, wherein:
the correspondence position relationship
designates two or more prescribed actual positions as specific positions,
establishes the one-to-one correspondence between (i) the position information indicative of each specific position and (ii) the image position corresponding to the each specific position, and
establishes a relation between (i) the actual position other than the specific positions and (ii) the image position corresponding to the actual position other than the specific positions, by using piecewise-polynomial interpolation with an expression derived from the one-to-one correspondence between the position information indicative of each specific position and the image position corresponding to the each specific position.

3. The steering wheel grip detection apparatus according to claim 1, further comprising:
grip state identification means for identifying a grip state of the steering wheel when the determination means determines that the steering wheel is gripped.

4. The steering wheel grip detection apparatus according to claim 3, wherein:
the grip state identification means identifies the grip state as a both-hands grip state where the steering wheel is gripped with both hands, when the number of hand positions identified by the hand identification means is two or more and when the identified two or more hand positions are on the detection position identified by the position identification means.

5. The steering wheel grip detection apparatus according to claim 4, wherein:
the grip state identification means identifies the grip state as a one-hand grip state where the steering wheel is gripped with one hand, when the number of hand positions identified by the hand identification means is one and when the identified one hand position is on the detection position identified by the position identification means.

6. The steering wheel grip detection apparatus according to claim 4, wherein:
the grip state identification means
designates a plurality of prescribed points on the steering wheel as specific points,
identifies, as a grip position on the steering wheel, a region between two of the specific points, the region containing the detection position identified by the hand identification means, and
identifies the grip state from the grip position.

7. The steering wheel grip detection apparatus according to claim 1, further comprising:
warning means for outputting a warning for safe driving of the vehicle when the determination means determines that the steering wheel is not gripped.

8. A program product stored in a computer readable storage medium that causes a computer to function as a steering wheel grip detection apparatus through performing:
acquiring position information indicative of position of steering wheel in a vehicle compartment of a vehicle, wherein the position of the steering wheel is changeable in the vehicle compartment, wherein the position of the steering wheel in the vehicle compartment of the vehicle is actual position;
acquiring an image captured by an imaging device that is fixed to the vehicle to image a prescribed region of the vehicle compartment so that the prescribed region covers at least a movable range of the steering wheel, wherein the position of the steering wheel on the image is image position;
identifying, at least when the actual position is changed, the image position by applying (i) the acquired position information to (ii) a prescribed correspondence position relationship establishing a one-to-one correspondence between the position information and the image position, wherein the identified image position is detection position;
identifying hand position of a person appearing on the acquired image from the acquired image; and
determining whether the steering wheel is gripped, based on whether the identified hand position is on the identified detection position, wherein it is determined that the steering wheel is gripped when the identified hand position is on the identified detection position.
